(19) United States
(12) Patent Application Publication
(10) Pub. No.: US 2009/0024473 A1
(43) Pub. Date: Jan. 22, 2009

(54) SYSTEM AND METHOD FOR VIRTUAL EBOX MANAGEMENT

(76) Inventor: Maury Friedman, Agoura Hills, CA (US)

Correspondence Address: DREIER LLP;Susan Formicola, 499 PARK AVE, NEW YORK, NY, 10022, US

(21) Appl. No.: 11/930,009

(22) Filed: Oct. 30, 2007

Related U.S. Application Data
(60) Provisional application No. 60/950,909, filed on Jul. 20, 2007.

(51) Int. Cl. G06Q 30/00; G06Q 90/00

(52) U.S. Cl. 705/14

(57) ABSTRACT

The present invention is directed towards systems and methods for providing content to a plurality of users. The method of the present invention comprises generating an interactive coupon and transmitting said coupon to at least one electronic mailbox (eBox), said eBox corresponding to a geographical location. The method provides a graphical user interface to display said electronic mailbox and displays said coupon through said graphical user interface.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention disclosed herein relates generally to a system and methods for providing electronic mailboxes corresponding to physical locations. More specifically, the present invention is directed towards systems, methods and computer program products for providing an electronic mailbox (“eBox”) system allowing merchants, advertisers and other eBox users (e.g., senders) to transmit electronic messages based on geographic ranges and based on messaging settings set by the senders.

### BACKGROUND OF THE INVENTION

E-mail is currently one of the most popular methods of distributing electronic materials, such as personal messages, advertisements and the like. However, from a social perspective current e-mail techniques are lacking in a variety of different but equally important aspects.

The first of these aspects is access to an e-mail provider. Although free e-mail providers are abundant, they result in a lack of uniformity and an abundance of duplicate or mischievous accounts. Secondly, the current state of the art relies on address book based technology to send data. That is, a user must manually enter a plurality of recipient e-mail address either from memory or from an address book. This limitation does not allow a given user to fully exploit the global aspects of the Internet and e-mail. Thirdly, there is no provision in current systems that allow merchants to definitively distribute material to desired groups of individuals. For example, there is currently no means available to distribute e-mails to an entire city.

The present invention provides solutions to these limitations via a geography-based electronic mailbox (“eBox”) system. The system assigns an eBox to a given location, such as one eBox per physical address, and allows users to access their eBox from any location and at any time. The present invention further allows eBox users to transmit electronic messages to geographically defined ranges of electronic mailboxes. For example, a user may send messages to all residents of his or her block to inform them of an upcoming block party. Finally, the present invention allows merchants to transmit coupons, advertisements and the like to a set of eBox users according to finely grained criteria, thereby increasing the effectiveness of an advertisement campaign and its associated revenue.

### SUMMARY OF THE INVENTION

The present invention is directed towards systems, methods and computer program products for providing content to a plurality of users. The method of the present invention comprises generating an interactive coupon. According to one embodiment, generating an interactive coupon comprises providing a merchant interface for creating an interactive coupon or modifying an existing interactive coupon. In an alternative embodiment, generating an interactive coupon comprises selecting at least one parameter controlling the use of said interactive coupon. At least one parameter may comprise a plurality of recipient electronic mailboxes (“eBox”). In a third alternative embodiment, a method of the invention may further comprise validating a plurality of recipient eBoxes, said validating comprising temporarily adding an invalid eBox to an eBox database, verifying an address associated with said temporary eBox, saving a verified temporary eBox, and removing an unverified temporary eBox.

The method then transmits said coupon to at least one electronic mailbox, said eBox corresponding to a geographical location and provides a graphical user interface to display said electronic mailbox. In one embodiment, providing a graphical user interface further comprises providing a log-in page. In this embodiment, a log-in page may comprise at least one input element associated with a geographical address. In an alternative embodiment, the method may further comprise monitoring said coupon and updating at least one coupon parameter in response to said monitoring.

Finally, the method displays said coupon through said graphical user interface. In a first embodiment, displaying said coupon further comprises storing an alphanumeric identifier on a displaying device. In a second embodiment, displaying said coupon comprises displaying said coupon in accordance with a predefined display profile.

The present invention is further directed towards a system for content to a plurality of users. The system of the present invention comprises a plurality of client devices coupled to a network. The system further comprises a content server operative to transmit electronic coupons to said client devices and provide a graphical user interface for viewing said coupons. According to a first embodiment, generating an interactive coupon comprises creating an interactive coupon or modifying an existing interactive coupon. In an alternative embodiment, generating an interactive coupon comprises selecting at least one parameter controlling the use of said interactive coupon. At least one parameter may comprise a plurality of recipient eBoxes. In one embodiment, a content server may further be operative to validate a plurality of recipient eBoxes, said validating comprising temporarily adding an invalid eBox to an eBox database, verifying an address associated with said temporary eBox, saving a verified temporary eBox and removing an unverified temporary eBox.

In one embodiment, providing a graphical user interface further comprises providing a log-in page, said log-in page comprising at least one input element associated with a geographical address. In one embodiment, displaying said coupon further comprises storing an alphanumeric identifier on a displaying device. In an alternative embodiment, displaying said coupon comprises displaying said coupon in accordance with a predefined display profile.

The system further comprises an eBox database coupled to said content server operative to maintain a relationship between an eBox and a geographical location and a marketing interface coupled to said content server operative to generate an interactive coupon. In alternative embodiment, the system may further comprise a yield management engine operative to monitor said coupon and update at least one coupon parameter in response to said monitoring.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating a system for providing an eBox system for a plurality of end users and merchants according to one embodiment of the present invention;

FIG. 2 presents a flow diagram illustrating a method for displaying merchant coupons using an eBox system according to one embodiment of the present invention;

FIG. 3 presents a flow diagram illustrating a method for creating and monitoring merchant campaigns using the eBox system according to one embodiment of the invention according to one embodiment of the present invention;

FIG. 4 presents a flow diagram illustrating a method of managing an advertisement campaign in an eBox system according to one embodiment of the invention according to one embodiment of the present invention; and

FIG. 5 presents a flow diagram illustrated a method of handling invalid eBoxes in accordance with one embodiment of the invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

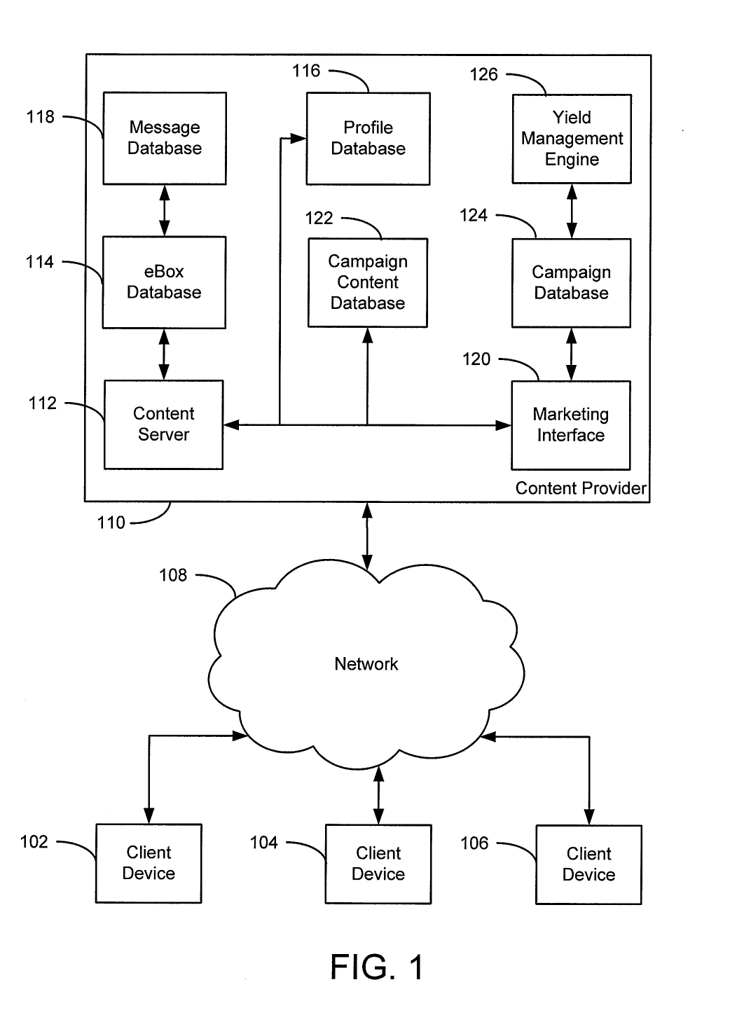

FIG. 1 presents a block diagram depicting a system for providing eBoxes to users and merchants according to one embodiment of the present invention. According to the embodiment illustrated in FIG. 1, a system 100 comprises a plurality of client devices 102, 104 and 106 coupled to a network 108. According to one embodiment of the invention, a given client device 102, 104 and 106 is a general purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage and an Ethernet interface to a network. Other client devices are considered to fall within the scope of the present invention including, but not limited to, hand held devices, set top terminals, mobile handsets, PDAs, etc.

A given client devices 102, 104 and 106 may be in contact with a content provider 110 via a communications network 108. As illustrated, the content provider 110 may comprise a plurality of components operative to transmit static and dynamic content items from content provider 110 to a plurality of client devices 102, 104 and 106. According to one embodiment, static and dynamic contents items may comprise HTML pages, JavaScript, Cascading Style Sheets, images, video, etc.

A content provider 110 comprises a content server 112 operative to receive requests from client devices 102, 104 and 106, generate content items and transmit content items to client devices 102, 104 and 106. For example, a content server 112 may comprise a web server such as Apache or Internet Information Server. In one embodiment, content server 112 may be operative to receive an eBox request from a client device 102-108. In one embodiment, an eBox request may comprise a request to view the content of an eBox. For example, a user may access a login page requesting the address or phone number associated with a given eBox. In response to the log-in information, content server 112 may retrieve the content of the associated eBox, as will be described in greater detail herein.

The content server 112 is communicatively coupled to an eBox database 114. In one embodiment, an eBox database 114 may comprise data related to the identity of a plurality of eBoxes. For example, eBox database 114 may be operative to receive a physical address from content server 112 and translate the physical address to an eBox identifier, such as an alphanumerical code. In alternative embodiments, content server 112 may be operative to transmit a plurality of alternative eBox ranges such as zip codes, area codes, street names or cities, etc. EBox database 114 may further be operative to translate a broader geographical area to a plurality of distinct eBox identifiers resident within the given area.

EBox database 114 may be communicatively coupled to a profile database 1 16. A profile database 1 16 may comprise a plurality of parameters identifying various aspects of a given eBox. For example, profile database 116 may comprise one or more demographic metrics such as income level, socioeconomic status, educational level, marital status, ownership (home, car, pet, etc) or languages spoken, etc. Alternatively, or in conjunction with the foregoing, a profile database 116 may comprise one or more presentation settings such as alternate display devices (cellphones, regular e-mail, etc), mail filters (e.g., filtering by sender, address of sender, keywords, etc) or user alerts (e.g., alerting a user based on keyword analysis of incoming messages). In response to a request for data to content server 112, content server 112 may be operative to retrieve formatting data from profile database 116 and format the returned data from eBox database 114 or message database 118.

EBox database 114 is further coupled to message database 118. Message database 118 comprises a storage component operative to store one or more messages corresponding to a given eBox. According to the embodiment of FIG. 1, eBox database 114 may transmit a given eBox identifier to a message database 118, which returns one or more messages associated with a given identifier.

The system 100 may further comprise a marketing interface 120. Marketing interface 120 may comprise a graphical user interface (“GUI”) operative to provide a given merchant with an easy to user interface for creating advertising campaigns using the content provider 110. Marketing interface 120 may be coupled to both campaign content database 122 and campaign database 124.

Campaign content database 122 may comprise a plurality of graphical, textual, audio or video content items associated with a given campaign. Although illustrated as residing within content provider 110, campaign content database 122 may reside in a remote content provider (not pictured), reducing the load of a given content provider 110.

According to the embodiment of FIG. 1, a campaign database 124 may comprise data related to the operation or execution of a given campaign. For example, campaign database 124 may store a plurality of parameters controlling the operation of a campaign. In one embodiment, a campaign database 124 may comprise a plurality of eBox recipients for a given campaign. For example, a list of recipients may be stored, the list of recipients designated by mailing address, street name, area code(s), zip code(s), city name(s), regions selected from a map or neighborhood name tags, etc.

Campaign database 124 may further be coupled to a yield management engine 126. The yield management engine 126 is operative to monitor or manage a given campaign stored within campaign database 124 and update (e.g., add or remove) campaign parameters based on the basis of activity of a given campaign. For example, a campaign may be set up to change a discount level of a coupon on the basis of the number of tickets available and the date of upcoming event. If a predetermined number of tickets are still available within a number of days of the event, yield management engine 126 may reduce the price of the tickets advertised within the coupon to increase the number of tickets sold.

In addition to creating campaigns, marketing interface 120 may further allow a merchant to manually modify an existing campaign. In one embodiment, this functionality may be implemented by a graphical “wizard” interface that the marketing interface 120 provides to the merchant. A wizard interface enables a merchant to create, delete and monitor existing campaigns in real-time, allowing full control over a given campaign.

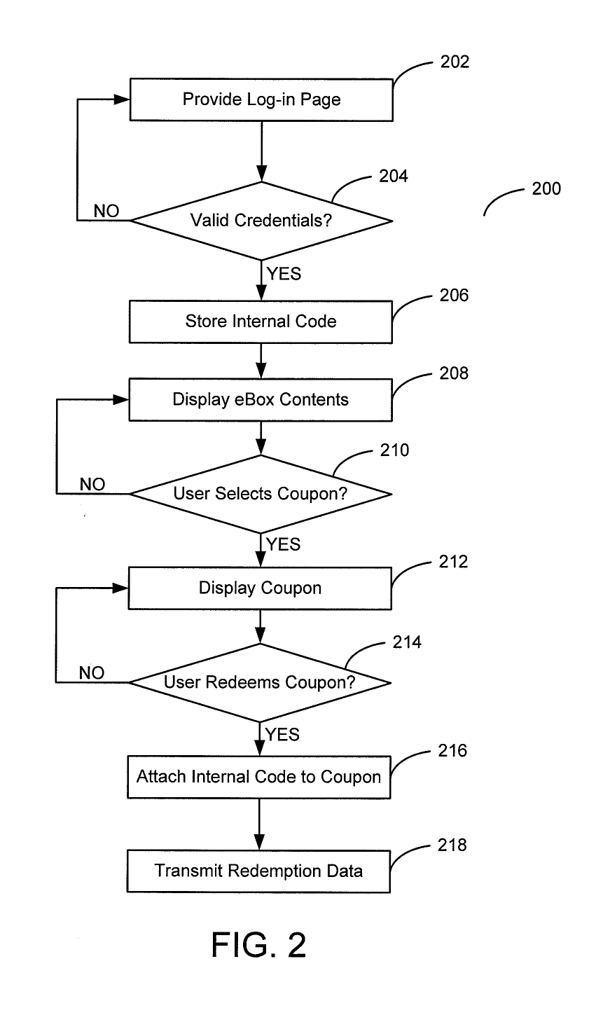

FIG. 2 provides a flow diagram illustrating a method for displaying merchant coupons using an eBox system according to one embodiment of the present invention. As illustrated, a method 200 provides a log-in page to a user, step 202. In one embodiment, a log-in page may comprise an HTML page enabling a user to supply a physical address or phone number. In this embodiment, a user may not be required to enter a password or similar authentication means to access the eBox contents.

The method 200 validates the credentials that a user enters, step 204. If the credentials are invalid, the log-in page is redisplayed to the user, step 202. If the credentials are valid, the method may store an internal code at the client device, step 206. According to one embodiment, an internal code comprises a cookie that contains a unique identifier for a given eBox. For example, an identifier “725FXY112D” may be associated with a given address “1234 Main Street, Park City, Utah”. In this embodiment, an identifier may not have any resemblance to the address and may comprise an alphanumerical combination. An internal code stored may be utilized in a variety of applications including, but not limited to management and control of the security and privacy of the eBox, given to vendors instead of the eBox address, used by vendors to send mail, eCommerce and customer relations information without disclosure of physical addresses, mail forwarding or used as a national ID system.

The content of a given eBox may be displayed to the user, step 208. The eBox contents remain displayed until a user selects a given coupon, step 210. If the user selects a coupon, the coupon is displayed to the user, step 212. According to one embodiment, displaying a message comprises displaying details of a given coupon provided by one or more merchants. For example, a given merchant may provide one or more graphical elements and associated hyperlinks allowing a user to select a given hyperlink and fulfill a displayed offer. For example, a car dealership may create a coupon containing at least an interactive element such as an image comprising the text “Click to schedule at test drive.”

If a user does not redeem a coupon, the coupon remains displayed, step 214. Alternative embodiments, may exist where a user may return to view the contents of an eBox instead of continuing to display a coupon as illustrated in steps 212 and 214. If a user redeems a coupon, the internal code may be attached to the coupon redemption notice, step 216. Attaching an internal code to a redemption notice allows a merchant to verify the identity of a redeeming eBox user upon request, step 218.

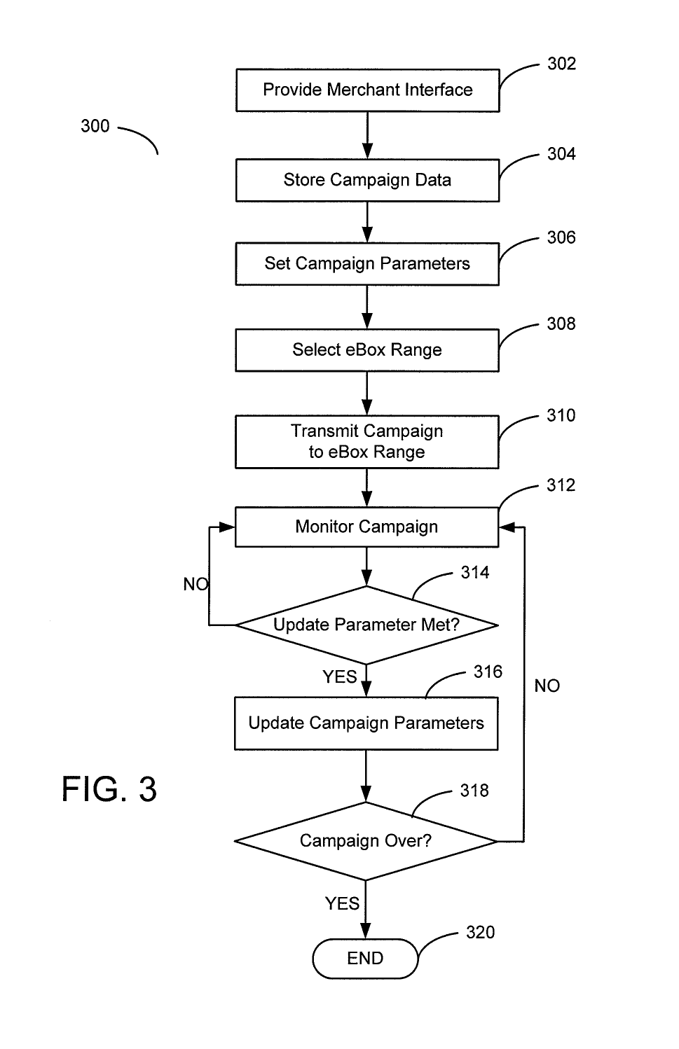

FIG. 3 presents a flow diagram illustrating a method for creating and monitoring merchant campaigns according to one embodiment of the present invention. As FIG. 3 illustrates, a merchant interface is provided to a merchant, step 302, which may comprise displaying an interactive webpage to a merchant. In one embodiment, a merchant is assigned a unique eBox. In an alternative embodiment, a merchant may not be assigned to a specific eBox.

According to the illustrated embodiment of FIG. 3, a method 300 stores campaign data related to a given campaign, step 304. In one embodiment, storing campaign data comprises uploading one of more content items to a content data store. For example, a merchant may upload one or more images, text, video or other multimedia comprising an advertisement to a content data store.

A plurality of campaign parameters associated with a given campaign may then be set, step 306. As previously described, in one embodiment, parameters may include one or more of settings monitoring the campaign, such as the length of the campaign, the level of discounts and various other parameters sent to a yield management engine, as previous described. Following the selection of parameters, an eBox range is selected, step 308. An eBox range may be selected based on mailing address(es), street name(s), area code(s), zip code(s), city name(s), regions selected from a map or neighborhood name tags, etc.

The method 300 transmits the campaign data to the selected eBoxes, step 310, and monitors the campaign, step 312, until a performance parameter is met, step 314. In one embodiment, monitoring a campaign may comprise monitoring one or more statistics (e.g., campaign views, campaign sales, etc) associated with a given campaign. A given parameter associated with a campaign, if met, may result in one or more campaign parameters being updated, step 316. For example, if a predetermined number of tickets are still available within 5 days of the event, the method 300 may reduce the price of the tickets advertised within the coupon to increase the number of tickets sold.

Steps 312, 314, and 316 may be continually executed until a campaign is determined to be over, step 318. In one embodiment, the end of a campaign may be determined dynamically on the basis of one or more campaign parameters. For example, a ticket selling campaign may automatically end after all tickets have been redeemed. In an alternative embodiment, a merchant may manually end a given campaign via a merchant interface. Upon ending a campaign, the campaign transmitted by step 310 may be deleted from each eBox mailbox. In an alternative embodiment, the campaign may remain present within the plurality of eBoxes, although rendered inactive.

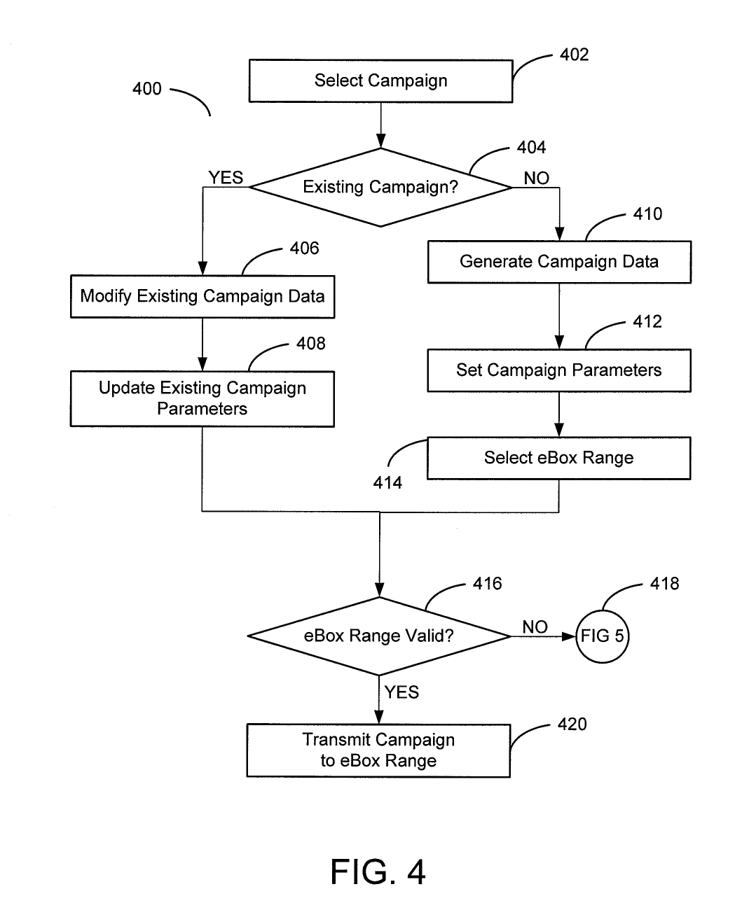

FIG. 4 presents a flow diagram illustrating a method of managing an advertisement campaign in an eBox system according to one embodiment of the invention. As FIG. 4 illustrates, a merchant may select a campaign, step 402. In one embodiment, selecting a campaign may involve entering a campaign ID into a merchant interface.

If a campaign exists, a merchant may be provided with an interface to modify the existing campaign, step 406. As previously described, modifying a campaign may comprise modifying one or more stored content items associated with a campaign. For example, an ad campaign comprising an advertisement image may be updated by a merchant to reflect a change in theme, change in advertisement terms or similar circumstances. In addition to updating one or more campaign data items, a plurality of campaign parameters may be updated, step 408. As previously described, a merchant may modify a campaign's parameters in real time after it has been distributed to the campaign recipients. For example, a merchant may modify the recipients of a campaign by adding or removing recipients via a merchant interface.

If a campaign does not exist, a new campaign may be created, steps 410 and 412. According to one embodiment, a campaign is generated by first creating one or more campaign data items, step 410. As previously described, a campaign data item may comprise a text file, image, video, sound, or other multimedia item, and may also comprise a presentation framework, such as an HTML, CSS or any other documents controlling the display of data. A merchant may then set one or more campaign parameters setting forth the operation of the campaign, step 412. For example, a given campaign parameter may comprise a campaign length (e.g., active for one week). Following the selection of parameters, an eBox range is selected, step 414. An eBox range may be selected based on mailing address(es), street name(s), area code(s), zip code(s), city name(s), regions selected from a map or neighborhood name tags, etc.

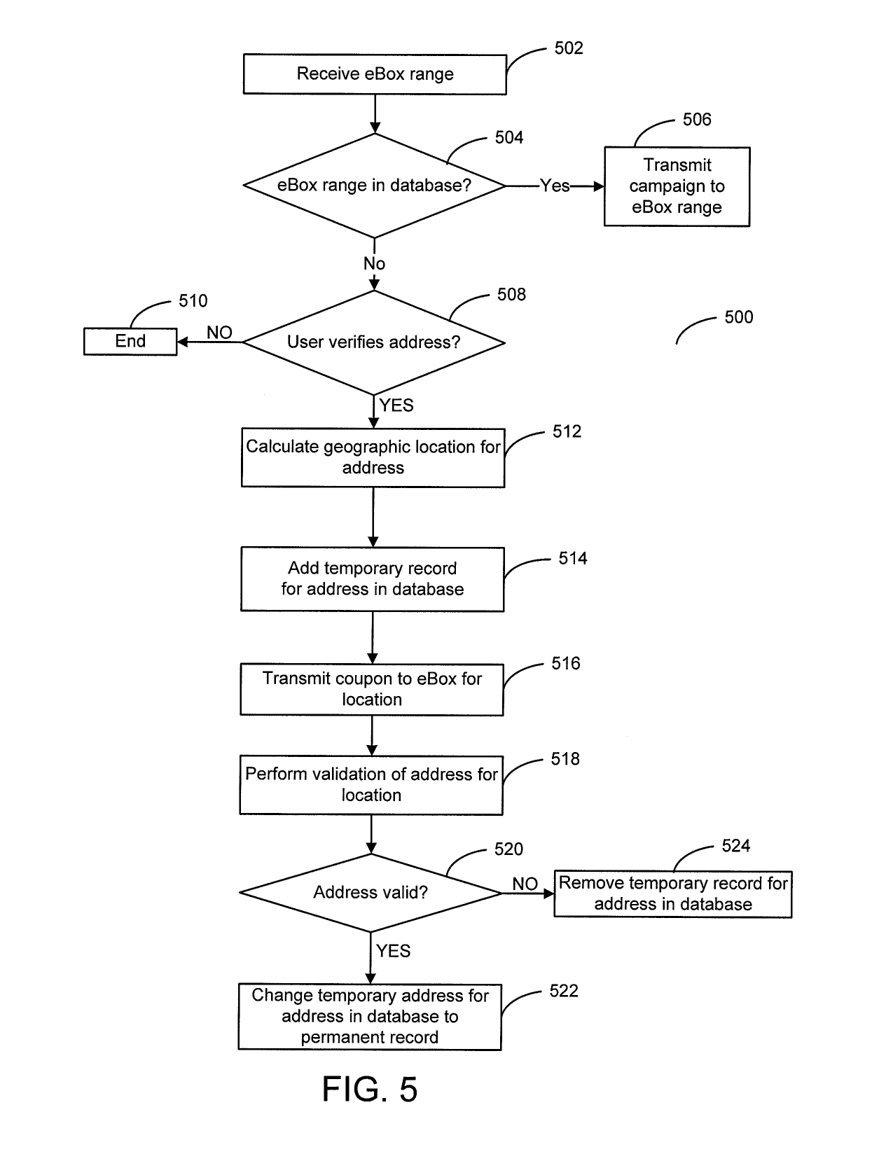

For both new campaigns and existing campaigns, the method 400 determines if the eBox range (or updated range) is valid, step 416. A check for a valid eBox range may comprise determining the selected eBoxes are present within a database of valid eBoxes. If there exists a given eBox that is not present in a database, an invalid eBox method may be invoked to handle the error condition, step 418. A method of handling invalid eBoxes is described more fully described with respect to FIG. 5. If the range of eBoxes is valid, the campaign is transmitted to the plurality of eBoxes, step 420.

FIG. 5 presents a flow diagram illustrated a method of handling invalid eBoxes in accordance with one embodiment of the present invention. As illustrated, the method 500 receives a location query, step 502. If the eBox range exists in the eBox database, step 504, the campaign is transmitted to the eBox range, step 506.

If the eBox range contains invalid eBoxes, step 504, a check is made to determine if a user verifies a given eBox, step 508. In one embodiment, an invalid eBox comprises an eBox corresponding to a location that is not present within the eBox database. For example, an eBox database may contain identifiers for “123 Main Street” and “125 Main Street”, but not “124 Main Street”. If an eBox range, such as “Main Street”, is identified, the address “124 Main Street” comprises an invalid eBox. Upon locating an invalid eBox, a check may be made, such as by an alert dialogue, to confirm that a merchant wishes to transmit the campaign to the invalid eBoxes. If the merchant declines, the method ends, step 510.

If the merchant decides to transmit the campaign to a given invalid address, a geographic location is calculated for a given address, step 512. For example, if an eBox range of “New York, N.Y.” is received, a plurality of invalid addresses may be computed from the given range, for example, eBoxes for unfound locations such as “111 7^{th} Ave”, “435 24^{th} St.”, etc. The calculated address may then be stored within an eBox database, step 514.

The campaign is transmitted to the eBox range, including the potentially invalid eBoxes, step 516. Following the transmission, validation of the invalid addresses is performed for a given address, step 518. In one embodiment, validation may comprise querying a global location database to determine if a given temporary eBox exists. For example, a given address such as “111 7^{th} Ave” is compared against a location database to determine if the mailing address of “111 7^{th} Ave” exists.

If the eBox address is valid, a given temporary eBox is converted to a permanent eBox in the eBox database, 522. In one embodiment, the conversion of a temporary eBox to a permanent eBox may comprise modifying a temporary value, such as a binary identifier, within the eBox database. In alternative embodiment, converting a temporary eBox to a permanent eBox may comprise adding additional eBox details to the eBox database. If the eBox location is not found in a global location database, e.g. a database provided by the United States Postal Service, the temporary address is removed from the eBox database, step 524.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for providing content to a plurality of users, the method comprising:
generating an interactive coupon;
transmitting the coupon to at least one eBox, the eBox corresponding to a geographical location;
providing a graphical user interface to display said electronic mailbox on a client device;
storing an eBox identifier on said client device; and
displaying said coupon through said graphical user interface.

2. The method of claim 1 wherein generating an interactive coupon comprises providing a merchant interface for creating an interactive coupon or modifying an existing interactive coupon.

3. The method of claim 1 wherein generating an interactive coupon comprises selecting at least one parameter controlling the use of said interactive coupon.

4. The method of claim 3 wherein at least one parameter comprises a plurality of recipient eBoxes.

5. The method of claim 4 further comprising validating a plurality of recipient eBoxes, said validating comprising:
temporarily adding an invalid eBox to an eBox database;
verifying an address associated with said temporary eBox;
saving a verified temporary eBox; and
removing an unverified temporary eBox.

6. The method of claim 1 further comprising monitoring said coupon and updating at least one coupon parameter in response to said monitoring.

7. The method of claim 1 wherein providing a graphical user interface further comprises providing a log-in page.

8. The method of claim 7 wherein said log-in page comprises at least one input element associated with a geographical address.

9. The method of claim 1 wherein displaying said coupon further comprises storing an alphanumeric identifier on a displaying device.

10. The method claim 1 wherein displaying said coupon comprises displaying said coupon in accordance with a predefined display profile.

11. A system for providing content to a plurality of users, the system comprising:
a plurality of client devices coupled to a network;
a content server operative to transmit electronic coupons to said client devices and provide a graphical user interface for viewing said coupons, the graphical user interface operable to store an eBox identifier on a client device in response to viewing said coupons;
an eBox database coupled to said content server operative to maintain a relationship between an eBox and a geographical location; and
a marketing interface coupled to said content server operative to generate an interactive coupon.

12. The system of claim 11 generating an interactive coupon comprises creating an interactive coupon or modifying an existing interactive coupon.

13. The system of claim 11 wherein generating an interactive coupon comprises selecting at least one parameter controlling the use of said interactive coupon.

14. The system of claim 13 wherein at least one parameter comprises a plurality of recipient eBoxes.

15. The system of claim 14 wherein said content server is further operative to temporarily add an invalid eBox to the eBox database, verify an address associated with said temporary eBox, save a verified temporary eBox and remove an unverified temporary eBox.

16. The system of claim 11 further comprising a yield management engine operative to monitor said coupon and update at least one coupon parameter in response to said monitoring.

17. The system of claim 11 wherein providing a graphical user interface further comprises providing a log-in page.

18. The system of claim 17 wherein said log-in page comprises at least one input element associated with a geographical address.

19. The system of claim 11 wherein displaying said coupon further comprises storing an alphanumeric identifier on a displaying device.

20. The system claim 11 wherein displaying said coupon comprises displaying said coupon in accordance with a predefined display profile

21. Computer readable media comprising program code for execution by a programmable processor that instructs the processor to perform a method for providing content to a plurality of users, the computer readable media comprising:
program code for generating an interactive coupon;
program code for transmitting the coupon to at least one eBox, the eBox corresponding to a geographical location;
program code for providing a graphical user interface to display said electronic mailbox on a client device;
program code for storing an eBox identifier on said client device; and
program code for displaying said coupon through said graphical user interface.

22. The computer readable media of claim 21 wherein the program code for generating an interactive coupon comprises program code for providing a merchant interface for creating an interactive coupon or modifying an existing interactive coupon.

23. The computer readable media of claim 21 wherein the program code for generating an interactive coupon comprises program code for selecting at least one parameter controlling the use of said interactive coupon.

24. The computer readable media of claim 23 wherein at least one parameter comprises a plurality of recipient eBoxes.

25. The computer readable media of claim 24 comprising program code for validating a plurality of recipient eBoxes, said validating comprising:
program code for temporarily adding an invalid eBox to an eBox database;
program code for verifying an address associated with said temporary eBox;
program code for saving a verified temporary eBox; and
program code for removing an unverified temporary eBox.
